(19) United States
(12) Patent Application Publication
(10) Pub. No.: US 2011/0075648 A1
(43) Pub. Date: Mar. 31, 2011

(54) METHOD AND SYSTEM FOR WCDMA/HSDOA TIMING ADJUSTMENT

(76) Inventors: Hongwei Kong, Denville, NJ (US); Jun Wu, San Diego, CA (US); Radhakrishnan Kuzhipatt, Irvine, CA (US)

(21) Appl. No.: 12/570,736

(22) Filed: Sep. 30, 2009

(51) Int. Cl. H04B 7/216

(52) U.S. Cl. 370/342

(57) ABSTRACT

Aspects of a method and system for WCDMA/HSDPA timing adjustment may include adjusting an uplink transmission timing of a signal for transmission by a large adjustment step, utilizing a plurality of smaller adjustment steps, to generate an adjusted transmission signal. The transmission signal may be upsampled to a rate corresponding to the smaller adjustment step, which may generate an upsampled transmission signal. An adjusted upsampled transmission signal may be generated by inserting one or more of the smaller adjustment steps via one or more extra samples into the upsampled transmission signal to generate a delay, or removing one or more samples from the upsampled transmission signal to generate an advance. The adjusted upsampled transmission signal may be filtered and downsampled to generate the adjusted transmission signal.

### CROSS-REFERENCE TO RELATED APPLICATIONS/INCORPORATION BY REFERENCE

None.

### FIELD OF THE INVENTION

Certain embodiments of the invention relate to signal processing for communication systems. More specifically, certain embodiments of the invention relate to a method and system for WCDMA/HSDPA timing adjustment.

### BACKGROUND OF THE INVENTION

Mobile communications have changed the way people communicate and mobile phones have been transformed from a luxury item to an essential part of every day life. The use of mobile phones is today dictated by social situations, rather than hampered by location or technology. While voice connections fulfill the basic need to communicate, and mobile voice connections continue to filter even further into the fabric of every day life, the mobile Internet is the next step in the mobile communication revolution. The mobile internet is poised to become a common source of everyday information, and easy, versatile mobile access to this data will be taken for granted.

Third generation (3G) and fourth generation (4G) cellular networks are specifically designed to fulfill these future demands of the mobile internet. As these services grow in popularity and usage, factors such as cost efficient optimization of network capacity and quality of service (QoS) will become even more essential to cellular operators than it is today. These factors may be achieved with careful network planning and operation, improvements in transmission methods, and advances in receiver techniques. To this end, carriers need technologies that will allow them to increase throughput and, in turn, offer advanced QoS capabilities and speeds that rival those delivered by cable modem and/or DSL service providers. Recently, advances in multiple antenna technology and other physical layer technologies have started to significantly increase available communications data rates.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

A method and/or system for WCDMA/HSDPA timing adjustment, substantially as shown in and/or described in connection with at least one of the figures, as set forth more completely in the claims.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1A is a diagram illustrating exemplary cellular multipath communication between a base station and a mobile terminal, in connection with an embodiment of the invention.

FIG. 1B is an exemplary diagram illustrating available chip-level SINR for an uplink signal with sampling time error at the base station, in accordance with various embodiments of the invention.

FIG. 1C is a diagram illustrating an exemplary MIMO communication system, in accordance with an embodiment of the invention.

FIG. 2 is a diagram illustrating an exemplary apparatus for providing WCDMA/HSDPA timing adjustment, in accordance with an embodiment of the invention.

FIG. 3 is a diagram illustrating an exemplary polyphase filter diagram, in accordance with various embodiments of the invention.

FIG. 4 is a flow chart illustrating an exemplary timing adjustment for WCDMA/HSDPA, in accordance with various embodiments of the invention.

### DETAILED DESCRIPTION OF THE INVENTION

Certain embodiments of the invention may be found in a method and system for WCDMA/HSDPA timing adjustment. Exemplary aspects of the method and system for WCDMA/HSDPA timing adjustment may comprise adjusting uplink transmission timing of a signal for transmission by a large adjustment step, utilizing a plurality of smaller adjustment steps, to generate an adjusted transmission signal. The transmission signal may be upsampled to a rate corresponding to the smaller adjustment step, which may generate an upsampled transmission signal. An adjusted upsampled transmission signal may be generated by inserting one or more of the smaller adjustment steps via one or more extra samples into the upsampled transmission signal to generate a delay, or removing one or more samples from the upsampled transmission signal to generate an advance. The adjusted upsampled transmission signal may be filtered and downsampled to generate the adjusted transmission signal.

The filtering may be performed via a polyphase filter, which may have programmable coefficients. The programmable coefficients may be adjusted adaptively. The polyphase filter may be a finite-impulse response (FIR) filter, wherein the FIR filter may be a 240 taps filter, comprising a plurality of 12-tap filters. The large adjustment step may be a quarter chip-period, and the small adjustment step may be a twentieth of a chip period. The transmission signal may conform to a Universal Mobile Telecommunications Systems (UMTS) signal, and may be a transmission diversity signal.

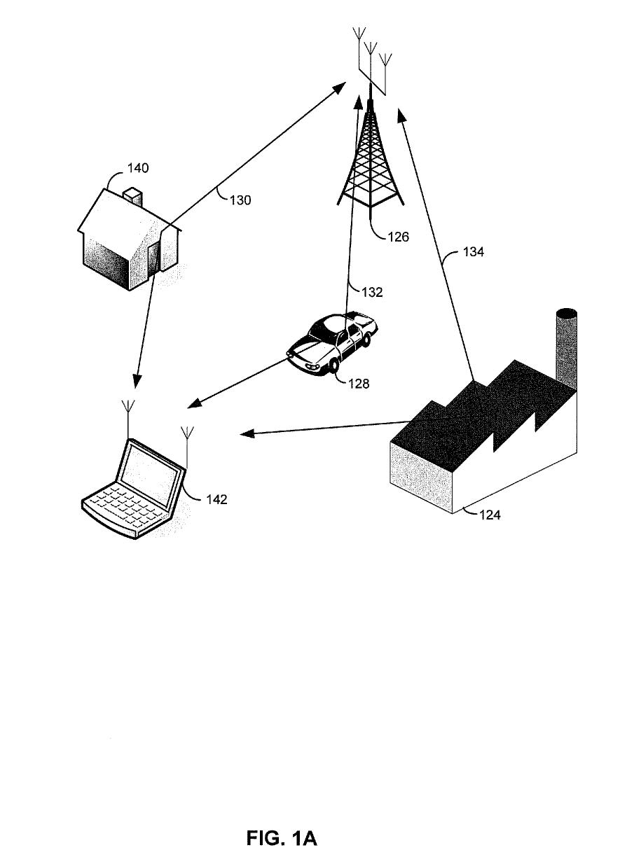

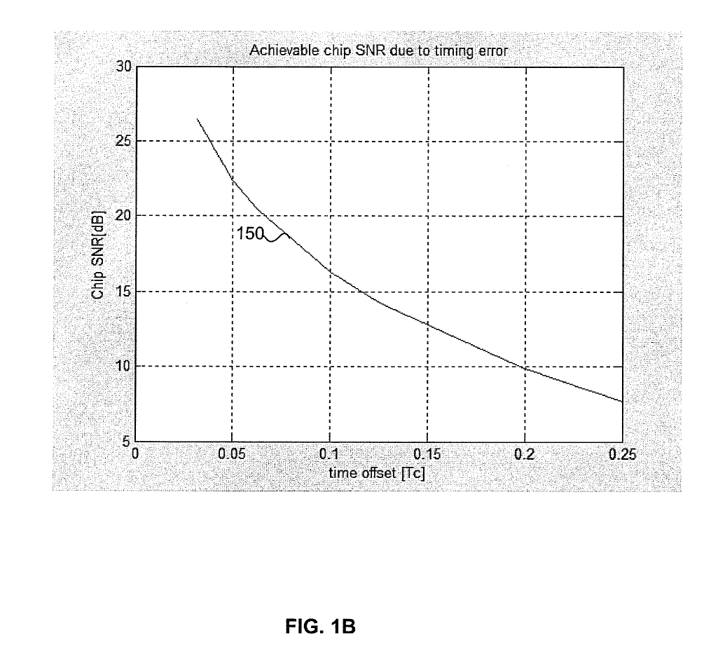

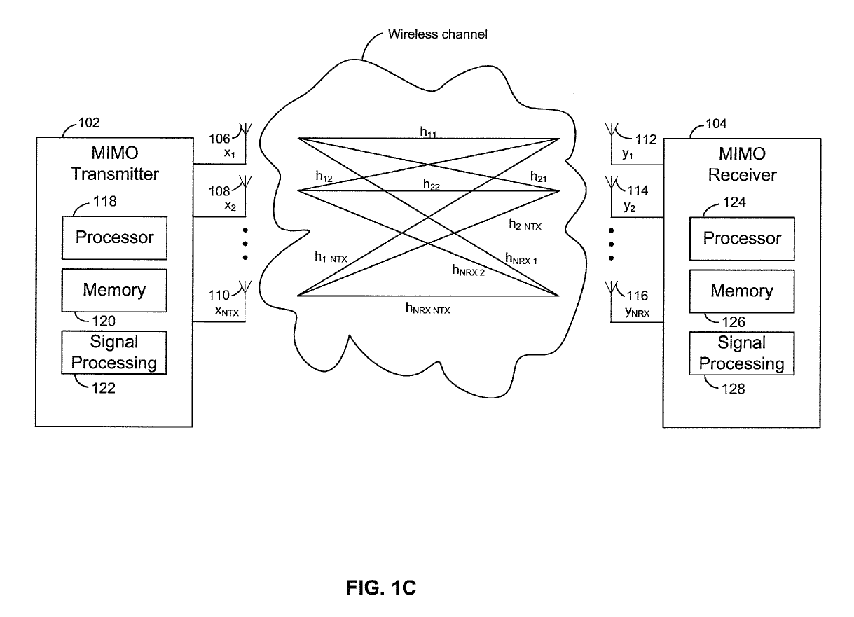

FIG. 1A is a diagram illustrating exemplary cellular multipath communication between a base station and a mobile terminal, in connection with an embodiment of the invention. Referring to FIG. 1A, there is shown a building 140 such as a house or office, a mobile terminal 142, a factory 124, a base station 126, a car 128, and communication paths 130, 132 and 134.

The base station 126 and the mobile terminal 142 may comprise suitable logic, circuitry, interfaces and/or code that may be enabled to generate and process (multiple input multiple output) MIMO communication signals.

Wireless communications between the base station 126 and the mobile terminal 142 may take place over a wireless channel. The wireless channel may comprise a plurality of communication paths, for example, the communication paths 130, 132 and 134. A wireless channel comprising a plurality of communication paths, for example communication paths 130, 132, and 134 may also be referred to as a multipath channel. The wireless channel may change dynamically as the mobile terminal 142 and/or the car 128 moves. In some cases, the mobile terminal 142 may be in line-of-sight (LOS) of the base station 126. In other instances, there may not be a direct line-of-sight between the mobile terminal 142 and the base station 126 and the radio signals may travel as reflected communication paths between the communicating entities, as illustrated by the exemplary communication paths 130, 132 and 134. The radio signals may be reflected by man-made structures like the building 140, the factory 124 or the car 128, or by natural obstacles like hills. Such a system may be referred to as a non-line-of-sight (NLOS) communications system.

Signals communicated by the communication system may comprise both LOS and NLOS signal components. If a LOS signal component is present, it may be much stronger than NLOS signal components. In some communication systems, the NLOS signal components may create interference and reduce the receiver's performance. This may be referred to as multipath interference. The communication paths 130, 132 and 134, for example, may arrive with different delays at the mobile terminal 142. The communication paths 130, 132 and 134 may also be differently attenuated. In the downlink, for example, the received signal at the mobile terminal 142 may be the sum of differently attenuated communication paths 130, 132 and/or 134 that may not be synchronized and that may dynamically change. Such a channel may be referred to as a fading multipath channel. A fading multipath channel may introduce interference but it may also introduce diversity and degrees of freedom into the wireless channel. Communication systems with multiple antennas at the base station and/or at the mobile terminal, for example MIMO systems, may be particularly suited to exploit the characteristics of wireless channels and may extract large performance gains from a fading multipath channel that may result in significantly increased performance with respect to a communication system with a single antenna at the base station 126 and at the mobile terminal 142, in particular for NLOS communication systems.

The better the knowledge of the wireless channel, and thus also the characteristics of the multipath components, for example multipath components 130, 132, and 134, the higher the performance gains that may be achieved at the receiver. In some cases, the downlink and the uplink transmissions may be in a timing relationship to each other. For example, the uplink may be transmitted an exemplary 1024 chips after the downlink has been received. Since the wireless channel varies over time and transmission paths may become shorter or longer, the timing of the uplink transmission may also continually change. As a result, the timing of the uplink may need to be adjusted accordingly. For example, in accordance with various embodiments of the invention, it may be desirable to maintain a 1024 chips timing difference between the downlink and the uplink.

FIG. 1B is an exemplary diagram illustrating available chip-level SINR for an uplink signal with sampling time error at the base station, in accordance with various embodiments of the invention. Referring to FIG. 1B, there is shown an achievable SINR curve 150. There is also shown a horizontal time offset axis, and a vertical chip SNR/SINR axis.

Some WCMA standards may prescribe the step size by which the uplink timing may be adjusted, for example a quarter chip-period Tc/4. However, such step sizes may be relatively large in circumstances where high Signal-to-Noise-and-Interference-Ratio (SINR) may be required. This may be the case, for example, in high-rate data communications, and high-order modulation schemes. When the timing adjustment step size may be large, the SINR at the receiver may degrade and negatively impact the achievable data rates. As illustrated in FIG. 1B, the exemplary achievable SINR curve 150 may illustrate how the chip SNR/SNIR on the vertical axis degrades with increasing time offset on the horizontal time offset axis. Thus, in accordance with various embodiments of the invention, the uplink step size, for example, a Tc/4 may be implemented using a plurality of smaller steps, for example steps of size Tc/20. The smaller steps may enable better tracking and locking of the uplink transmission timing at the base station receiver, and may also enable a higher signal quality to be maintained (higher SINR as illustrated in FIG. 1B), which in turn allows higher data rates. In some cases, the smaller step size may also avoid phase discontinuities, and result in a smoother frequency spectrum.

FIG. 1C is a diagram illustrating an exemplary MIMO communication system, in accordance with an embodiment of the invention. Referring to FIG. 1C, there is shown a MIMO transmitter 102 and a MIMO receiver 104, and antennas 106, 108, 110, 112, 114 and 116. The MIMO transmitter 102 may comprise a processor block 118, a memory block 120, and a signal processing block 122. The MIMO receiver 104 may comprise a processor block 124, a memory block 126, and a signal processing block 128. There is also shown a wireless channel comprising communication paths h₁₁, h₁₂, h₂₂, h₂₁, h_{2 NTX}, h_{1 NTX}, h_{NRX 1}, h_{NRX 2}, h_{NRX NTX}, where hₘₙ may represent a channel coefficient from transmit antenna n to receiver antenna m. There may be N_{TX} transmitter antennas and N_{RX} receiver antennas. There is also shown transmit symbols x₁, x₂ and x_{NTX}, and receive symbols y₁, y₂ and y_{NRX}.

The MIMO transmitter 102 may comprise suitable logic, circuitry, interfaces and/or code that may be enabled to generate transmit symbols xᵢ i ε{1, 2, . . . N_{TX}} that may be transmitted by the transmit antennas, of which the antennas 106, 108 and 110 may be depicted in FIG. 1C. The processor block 118 may comprise suitable logic, circuitry, interfaces, and/or code that may be enabled to process signals. The memory block 120 may comprise suitable logic, circuitry, interfaces, and/or code that may be enabled to store and/or retrieve information for processing in the MIMO transmitter 102. The signal processing block 122 may comprise suitable logic, circuitry, interfaces and/or code that may be enabled to process signals, for example in accordance with one or more MIMO transmission protocols. The MIMO receiver 104 may comprise suitable logic, circuitry, interfaces and/or code that may be enabled to process the receive symbols yᵢ i ε{1, 2, . . . N_{RX}} that may be received by the receive antennas, of which the antennas 112, 114 and 116 may be shown in FIG. 1C. The processor block 124 may comprise suitable logic, circuitry, interfaces, and/or code that may be enabled to process signals. The memory block 126 may comprise suitable logic, circuitry, interfaces, and/or code that may be enabled to store and/or retrieve information for processing in the MIMO receiver 104. The signal processing block 128 may comprise suitable logic, circuitry, interfaces and/or code that may be enabled to process signals, for example in accordance with one or more MIMO protocols. An input-output relationship between the transmitted and the received signal in a MIMO system may be written as:

y=Hx+n

where y=[y₁, y₂, . . . y_{NRX}]^{T} may be a column vector with N_{RX} elements. ^{T} may denote a vector transpose, H=[hᵢⱼ]: iε{1, 2, . . . N_{RX}}; jε{1, 2, . . . N_{TX}} may be a channel matrix of dimensions N_{RX} by N_{TX}, x=[x₁, x₂, . . . x_{NTX}]^{T} is a column vector with N_{TX} elements and n is a column vector of noise samples with N_{RX} elements.

The system diagram in FIG. 1C may illustrate an exemplary multi-antenna system as it may be utilized in a Universal Mobile Telecommunications Systems (UMTS). Over each of the N_{TX} transmit antennas, a symbol stream, for example x₁(t) over antenna 106, may be transmitted. A wireless channel h₁₂ from transmit antenna 108 to receive antenna 112, as illustrated in the figure, may be multi-dimensional. In particular, the wireless channel h₁₂ may comprise a temporal impulse response, comprising one or more multipath components, for example multipath components 130, 132, and 134 as illustrated in FIG. 1A. The wireless channels as illustrated in FIG. 1C depict a spatial dimension of the wireless channel because the transmitted signal from each transmit antenna may be received differently at each receiver antenna. Thus, a channel impulse response may be measured and/or estimated for each sub-carrier, for example. In accordance with various embodiments of the invention, a suitable communication system may employ, for example, transmit diversity and/or more general multiple input, multiple output system.

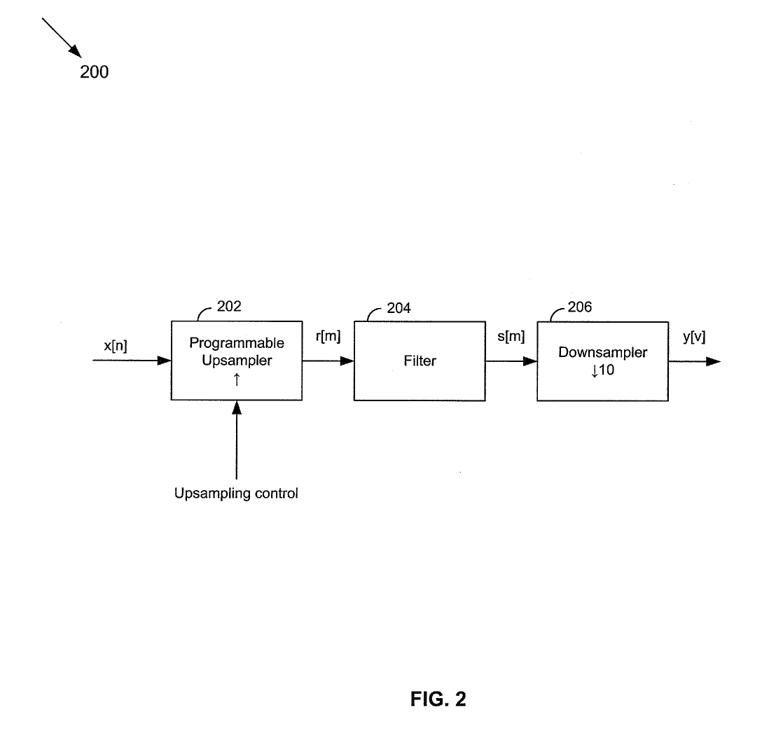

FIG. 2 is a diagram illustrating an exemplary apparatus for providing WCDMA/HSDPA timing adjustment, in accordance with an embodiment of the invention. Referring to FIG. 2, there is shown a timing adjustment circuit 200 comprising a programmable upsampler 202, a filter 204, and a downsampler 206. There is also shown an input signal x[n], an upsampled signal r[m], a filtered signal s[m], and an output signal y[v]. In accordance with various embodiments of the invention, the timing adjustment circuit 200 illustrated in FIG. 2 may be suitable for a transmitter located at a mobile terminal and/or a base station, and may comprise suitable logic, circuitry, interfaces and/or code that may be operable to adjust a timing of a transmission signal for further signal processing.

The programmable upsampler 202 may comprise suitable logic, circuitry, interfaces and/or code that may be operable to upsample a discrete-time input signal to higher-rate discrete-time output signal.

The filter 204 may comprise suitable logic, circuitry, interfaces and/or code that may be operable to generate an output signal comprising a different frequency spectrum from the frequency spectrum of an associated input signal.

The downsampler 206 may comprise suitable logic, circuitry, interfaces and/or code that may be operable to downsample a discrete-time input signal to a lower-rate discrete-time output signal.

To delay or advance a discrete-time signal, it may be advantageous to upsample the signal to a higher rate, time-shift and filter the signal, and downsample the signal. In this way, a signal may be time-shifted and its sampling rate may be adjusted accordingly. For example, an output signal oversampled by a factor of two may be achieved by upsampling by a factor of 20, and a downsampling by a factor of 10. For example, an input signal x[n] may be x[0], x[1], x[2], x[3], . . . at chip-rate, for example. When instances where no time shifting may be required, the programmable upsampler 202 may upsample to a 20 times higher data rate, by inserting 19 zeros after reach received sample x[n]. A stream of k zeros may be denoted by 0ₖ, for ease of notation, for example 0₄=0, 0, 0, 0. Thus, the upsampled signal r[m] at the output of the programmable upsample 202 may be x[0], 0₁₉, x[1], 0₁₉, x[2], 0₁₉, x[3], . . . , in instances where no time shifting is intended. The signal r[m] may be at an upsampled rate now, for example at a sample spacing of Tc/20, for an upsampling factor of 20.

In instances when a time shift operation is desirable because, for example, the uplink transmission timing may be adjusted to account for changing channel conditions, the time-shifting may be achieved by adding or subtracting one or more samples in the upsampler. For example, in instances when it is advantageous to introduce a time delay of Tc/20 at input signal x[1], this may be achieved by introducing an extra sample in the oversampling of the input signal, while maintaining a sample spacing of Tc/20. Hence, the upsampled signal r[m] may be x[0], 0₁₉, x[1], 0₂₀, x[2], 0₁₉, x[3], 0₁₉ . . . . Note that after x[1], 0₂₀, i.e. and extra sample over 0₁₉ may have been inserted, and thus the signal stream has been delayed by 1 sample. Similarly, when it is desirable to advance the signal stream, this may be achieved by introducing a reduced number of zero samples. For example, in instances when it is desirable to introduce a time lag of Tc/20 at input signal x[1], this may be achieved by introducing one less sample in the oversampling of the input signal, while maintaining a sample spacing of Tc/20. Hence, the upsampled signal r[m] may be x[0], 0₁₉, x[1], 0₁₈, x[2], 0₁₉, x[3], 0₁₉ . . . . After x[1], 0₁₈, i.e. one less sample over 0₁₉ may have been inserted, and thus the signal stream has been advanced by 1 sample.

In instances when the upsampled and possibly time-shifted signal r[m] is communicatively coupled to the filter 204, a filtered output signal s[m] may be generated with its frequency response adjusted to account for the multirate signal processing introduced by the programmable upsampler 202 and the downsampler 206. The filter 204 may be a low-pass filter, and may be implemented, for example as a polyphase filter. The downsampler 206 may be operable to reduce the sampling rate essentially by picking, for example, every tenth sample for a downsampling factor of 10. Hence, in accordance with various embodiments of the invention, a data rate conversion of N/K may be achieved by upsampling by a factor of N in the programmable upsampler 202, and downsampling by a factor K in the downsampler 206, and where N and K are integers.

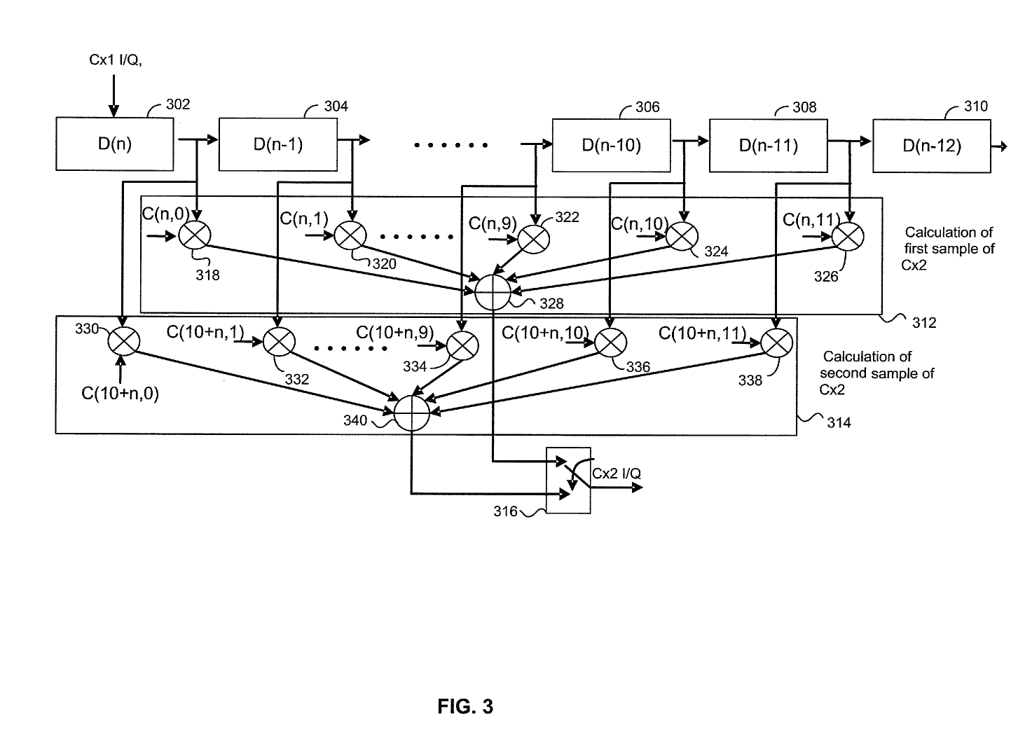

FIG. 3 is a diagram illustrating an exemplary polyphase filter, in accordance with various embodiments of the invention. Referring to FIG. 3, there is shown delay blocks 302, 304, 306, 308, and 310, a first sample generation block 312, a second sample generation block 314, and a switch 316. A first sample generation block 312 may comprise a plurality of multipliers, of which multipliers 318, 320, 322, 324, and 326 are illustrated, and an adder 328. The second sample generation block 314 may comprise a plurality of multipliers, of which multipliers 330, 332, 334, 336, and 338 may be illustrated, and an adder 340. There is also shown a plurality of multiplication coefficients C(k,m), a chip-rate input signal Cx1, and an output signal at twice the chip-rate, Cx2. D(n) may denote the delay block associated with a delay n.

The delay blocks 302, 304, 306, 308 and 310 may comprise suitable logic, circuitry, interfaces and/or code that may be operable to delay an input sample by one or more samples before it may appear at the output. The first sample generation block 312 and the second sample generation block 314 may comprise suitable logic, circuitry, interfaces and/or code that may be operable to form an output signal as a combination of a plurality of input signals, wherein the input signals may be combined by multiplication and/or addition. Such a combination may result, for example, in a filtering function. The switch 316 may comprise suitable logic, circuitry, interfaces and/or code that may be operable to switch either one of two inputs to an output. The multipliers 318, 320, 322, 324, 326, 330, 332, 334, 336, and 338 may comprise suitable logic, circuitry, interfaces and/or code that may be operable to generate an output signal that may be proportional to the product of a plurality of inputs. The adders 328 and 340 may comprise suitable logic, circuitry, interfaces and/or code that may be operable to generate an output signal that may be proportional to the sum of a plurality of input signals.

In accordance with various embodiments of the invention, a polyphase filter may be operable to oversample by a factor of two. A first sample and a second sample may be generated from an input sample Cx1 in the first sample generation block 312 and the second sample generation block 314, respectively. By switching the switch 316 at twice the chip rate, two generated samples Cx2 may be output for each input sample Cx1. A 240-tap filter, for example, may be implemented as a polyphase filter with 20 phases, wherein each phase may be a 12-tap FIR filter. The filter coefficients C(n,k) may be programmable under certain circumstances. The number of coefficients for each phase of the poly phase filter may change, for example depending on whether there is a time delay, or a time advance, or no time adjustment. The phases of the two filters implemented in the first sample generation block 312 and the second sample generation block 314 may be spaced by 10 samples, for example, as illustrated in FIG. 3. It may be desirable to use more delay blocks, for example delay blocks 302 through 308, than required taps. In an exemplary embodiment of the invention, a plurality of 13 delay blocks, of which delay blocks 302 through 308 are illustrated, may be utilized with 12-tap filters as illustrated in FIG. 3. In accordance with various embodiments of the invention, the filter coefficients, and in some cases the structure of the first sample generation block 312 and the second sample generation block 314 may be programmable.

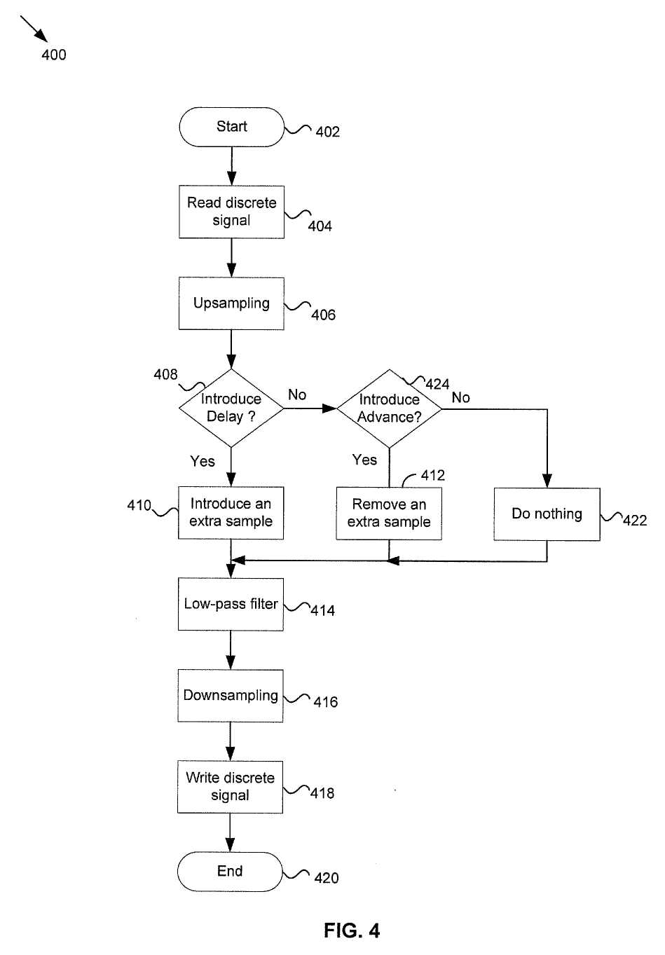

FIG. 4 is a flow chart illustrating an exemplary timing adjustment for WCDMA/HSDPA, in accordance with various embodiments of the invention. Referring to FIG. 4, a timing adjustment may commence and read a discrete input signal, for example x[n] as illustrated in FIG. 2, in steps 402 and 404. The discrete signal may be upsampled by introducing zero samples between the samples of the discrete signal in step 406, for example. In steps 408 and 424, it may be determined whether a delay, an advance, or no time shifting may be desirable. In instances where a time delay may be desirable, an extra zero sample may be introduced into the upsampled signal in step 410. In instances where a time advance may be desirable, a zero sample may be removed from the upsampled signal in step 412. In instances where no timing adjustment may be desirable, the upsampled signal remains unchanged in step 424. The adjusted and upsampled signal may then be low-pass filtered in step 414, in accordance with various embodiments of the invention. The filtered signal may be downsampled in step 416, and written to an output and/or memory, for example, in step 418.

In accordance with an embodiment of the invention, a method and system for WCDMA/HSDPA timing adjustment may comprise adjusting an uplink transmission timing of a signal for transmission by a large adjustment step, utilizing a plurality of smaller adjustment steps to generate an adjusted transmission signal, as illustrated in FIG. 1B, FIG. 2, FIG. 3, and FIG. 4. The transmission signal may be upsampled to a rate corresponding to the smaller adjustment step, for example in the programmable upsampler 202, which may generate an upsampled transmission signal at the output of the programmable upsampler 202. As illustrated in FIG. 4, an adjusted upsampled transmission signal may be generated by inserting one or more of the smaller adjustment steps via one or more extra samples into the upsampled transmission signal to generate a delay, as illustrated in step 410, or removing one or more samples from the upsampled transmission signal to generate an advance, as illustrated in step 412. The adjusted upsampled transmission signal may be filtered, for example in filter 204 or as illustrated in FIG. 3, and downsampled in a downsampling block 206 to generate the adjusted transmission signal.

As illustrated in FIG. 3, the filtering may be performed via a polyphase filter, which may have programmable coefficients, as shown for example in the first sample generation block 312 and/or the second sample generation block 314. The programmable coefficients may be adjusted adaptively. The polyphase filter may be a finite-impulse response (FIR) filter, wherein the FIR filter may be a 240 taps filter, comprising a plurality of 12-tap filters, as illustrated in FIG. 3. The large adjustment step may be a quarter chip-period, and the small adjustment step may be a twentieth of a chip period. The transmission signal may conform to a Universal Mobile Telecommunications Systems (UMTS) signal, and may be a transmission diversity signal.

Another embodiment of the invention may provide a machine-readable and/or computer-readable storage and/or medium, having stored thereon, a machine code and/or a computer program having at least one code section executable by a machine and/or a computer, thereby causing the machine and/or computer to perform the steps as described herein for a method and system for WCDMA/HSDPA timing adjustment.

Accordingly, the present invention may be realized in hardware, software, or a combination of hardware and software. The present invention may be realized in a centralized fashion in at least one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method for processing communication signals, the method comprising:
performing using one or more processors and/or circuits:
adjusting an uplink transmission timing of a signal for transmission by a large adjustment step, utilizing a plurality of smaller adjustment steps, to generate an adjusted transmission signal;
upsampling said transmission signal to a rate corresponding to said smaller adjustment step, to generate an upsampled transmission signal;
generating an adjusted upsampled transmission signal by inserting one or more of said smaller adjustment steps via one or more extra samples into said upsampled transmission signal to generate a delay, or removing one or more samples from said upsampled transmission signal to generate an advance; and
filtering and downsampling said adjusted upsampled transmission signal to generate said adjusted transmission signal.

2. The method according to claim 1, comprising performing said filtering via a polyphase filter.

3. The method according to claim 2, wherein said polyphase filter has programmable coefficients.

4. The method according to claim 2, comprising adjusting said programmable coefficients adaptively.

5. The method according to claim 2, wherein said polyphase filter has a plurality of programmable coefficients, and said plurality is a function of whether time delay, time advance, or no time adjustment is performed with said polyphase filter.

6. The method according to claim 2, wherein said polyphase filter is a finite-impulse response (FIR) filter.

7. The method according to claim 6, wherein said FIR filter may be a 240 taps filter, comprising a plurality of 12-tap filters.

8. The method according to claim 1, wherein said large adjustment step may be a quarter chip-period.

9. The method according to claim 1, wherein said small adjustment step is a twentieth of a chip period.

10. The method according to claim 1, wherein said transmission signal conforms to a Universal Mobile Telecommunications Systems (UMTS) signal.

11. The method according to claim 1, wherein said transmission signal is a transmission diversity signal.

12. A system for processing communication signals, the system comprising:
one or more circuits for use in a communication device, wherein said one or more circuits are operable to:
adjust an uplink transmission timing of a signal for transmission by a large adjustment step, utilizing a plurality of smaller adjustment steps, to generate an adjusted transmission signal;
upsample said transmission signal to a rate corresponding to said smaller adjustment step, to generate an upsampled transmission signal;
generate an adjusted upsampled transmission signal by inserting one or more of said smaller adjustment steps via one or more extra samples into said upsampled transmission signal to generate a delay, or removing one or more samples from said upsampled transmission signal to generate an advance; and
filter and downsample said adjusted upsampled transmission signal to generate said adjusted transmission signal.

13. The system according to claim 12, wherein said one or more circuits perform said filtering via a polyphase filter.

14. The system according to claim 13, wherein said polyphase filter has programmable coefficients.

15. The system according to claim 13, wherein said one or more circuits adjust said programmable coefficients adaptively.

16. The system according to claim 13, wherein said polyphase filter has a plurality of programmable coefficients, and said plurality is a function of whether time delay, time advance, or no time adjustment is performed with said polyphase filter.

17. The system according to claim 13, wherein said polyphase filter is a finite-impulse response (FIR) filter.

18. The system according to claim 17, wherein said FIR filter may be a 240 taps filter, comprising a plurality of 12-tap filters.

19. The system according to claim 12, wherein said large adjustment step may be a quarter chip-period.

20. The system according to claim 12, wherein said small adjustment step is a twentieth of a chip period.

21. The system according to claim 12, wherein said transmission signal conforms to a Universal Mobile Telecommunications Systems (UMTS) signal.

22. The system according to claim 12, wherein said transmission signal is a transmission diversity signal.
